(19) United States
(12) Patent Application Publication
(10) Pub. No.: US 2002/0158238 A1
(43) Pub. Date: Oct. 31, 2002

(54) Vehicle moving bar

(76) Inventor: Robert L. Parker, Beaverton, OR (US)

Correspondence Address: William S. Lovell, 6435 N E Neptune Drive, Lincoln City, OR, 97367, US

(21) Appl. No.: 09/611,826

(22) Filed: Dec. 11, 2000

Related U.S. Application Data
(63) Continuation-in-part of application No. 09/336,652, filed on Jun. 18, 1999, now abandoned.

(51) Int. Cl. B60S 9/22

(52) U.S. Cl. 254/36

(57) ABSTRACT

A vehicle moving bar comprises an elongate shaft having an outer extension near to one end that can provide a fulcrum, and a cross bar at the extremity of that one end, such that by disposition of said cross bar against a tire of a parked wheeled vehicle and of that outer extension against a floor underlying that parked vehicle, vertical pressure applied to the opposite end of the elongate shaft produces a lever action against the tire causing the vehicle to be moved a short distance.

### FIELD OF THE INVENTION

This invention relates to the manual, short-distance movement of parked motor vehicles and the like, for such purposes as performing maintenance thereon.

### BACKGROUND INFORMATION

It may often occur that a motor vehicle, such as a small automobile, a tractor or trailer of a semi-truck, or even larger wheeled vehicles, including various types of heavy equipment, may need to be moved short distances so as to lie within reach of an air hose or similar tethered equipment, to be aligned properly over a jack system so as to be lifted, for loading at a dock, so that the engine compartment or another part of the vehicle is situated under a crane for such purposes as engine replacement and the like, and for similar purposes. It may be inconvenient or impossible to start up the engine on such a vehicle so as to move it under its own power, or there may not be adequate space around the vehicle to carry out such maneuvers, whether under the power of the vehicle itself or that of another vehicle. The weight of the vehicle to be moved in particular will often prevent it from being moved by unassisted human force.

Substantial attention has been given to the task of moving large vehicles long distances in the conventional “car carrier,” and also to raising parts thereof. Thus, U.S. Pat. No. 5,871,330 issued Feb. 16, 1999 to Davenport describes a method of moving a semi-trailer portion of a vehicle, particularly a refuse collection vehicle, from a lowered position to a hoisted position, whereby the wheels of the semi-trailer portion may be moved a sufficient distance to be taken out of a “stuck” position and subsequently moved further using a towing vehicle.

U.S. Pat. No. 5,884,720 issued Mar. 23, 1999 to Ackerman describes a device that is attachable to the underside of the rear of a vehicle and bearing a wheel that can be extended down to permit transverse movement of that vehicle rear for purposes of ease of parking.

U.S. Pat. No. 5,878,472 issued Mar. 9, 1999 to Azeem describes a special purpose elongate bar structure adapted to be interposed vertically between upper and lower portions of a continuous track on a tracked vehicle, whereby the upper portion near to a wheel may be lifted to permit replacement of the wheel.

U.S. Pat. No. 5,367,732 issued Nov. 29, 1994 to Suggs, Sr., describes a tire handling tool comprising a forked steel bar that will hold a wheel-mounted tire two separated forks when the ends thereof are slid under a wheel that has been raised up and loosened, thereby to ease the awkward labor of handling such a wheel entirely manually.

U.S. Pat. No. 5,890,298 issued Apr. 6, 1999 to Panter describes a floor-mounted apparatus having ramped ends for centering a front and rear pair of vehicle wheels when the vehicle has been driven thereupon.

U.S. Pat. No. 5,709,520 issued Jan. 20, 1998 to Pish describes a wheel-lift apparatus into which aircraft wheel assemblies can be placed for movement within a hangar area or the like. The apparatus includes underlying on dolly wheels or casters by which it can be moved up laterally to surround a wheel assembly, and then the wheel assembly is raised up by mechanical means so that the wheel assembly can itself be moved about a floor.

In addition, Revolving Technologies, Inc., of Santa Clara, Calif., markets a pneumatically-driven device called an “Easy Mover” that resembles in size and shape a small vacuum cleaner; it operates from compressed air that can serve both to raise a load and then propel that load, or alternatively just to push (i.e., “roll”) a load such as industrial paper rolls or a wheeled vehicle.

None of the foregoing patents, however, addresses the frequent problem of needing to move a large vehicle some quite short distance in any direction after that vehicle has simply been parked on a flat surface, and the “Easy Mover” requires the use of an external force, i.e., compressed air. What is needed and would be useful, therefore, is a means of force magnification that would permit a mechanically-aided manual movement of the vehicle. Perhaps the longest known means of force magnification is the lever. However, a length of 2×4 lumber, a crow bar, or other such common elongate implements as may be found lying around and could serve as levers, are not convenient or well adapted for such purpose, in not being either sized or shaped for useful disposition against or under the typical pneumatic tires of motor vehicles, either in terms of an even distribution of force thereon or to achieve a non-slip disposition against both a tire of such a vehicle and against a shop floor. In particular, a 2×4 does not have any point thereon that could serve as a fulcrum, so that some additional piece of equipment would be required, and a crowbar, while having curved surfaces thereon that in principle could provide a fulcrum, would be extremely awkward to manipulate and in any event could well damage a tire instead of moving it. The present invention, since it includes its own fulcrum as well as means for coming safely into contact with a tire, is both much less expensive than the devices previously known in the art and well adapted for such an application, as will hereinafter be described.

### SUMMARY OF THE INVENTION

The invention comprises an elongate bar having at a first end thereof a cross piece sized to encounter a circumferential tire surface, and underlying that cross piece a curved surface adapted to contact an underlying floor, whereby tangential movement of a second end of the bar by the application of force by even a single person will apply a substantially magnified force to that tire, sufficient to move vehicles of substantial size and weight.

### BRIEF DESCRIPTION OF THE DRAWINGS

The preferred embodiments of the invention will now be described in detail with reference to the accompanying drawings, in which:

FIG. 1 is a side elevation view of a preferred embodiment of the invention.

FIG. 2 is a side elevation of an alternative embodiment of the invention having had a layer of non-slip material adhered to an end thereof that will engage a shop floor.

FIG. 3 is a top plan view of the device of FIGS. 1 and 2, showing in particular a cross-bar adapted to engage the under side of a vehicle-mounted wheel and tire.

FIG. 4 is a side elevation view of the device of FIGS. 1 and 3 being applied to an under surface of a vehicle mounted wheel and tire.

FIG. 5 is a somewhat enlarged view of a portion of the device of FIG. 4, illustrating a set of force vectors that can serve to describe the use of the invention.

### DETAILED DESCRIPTION OF THE INVENTION

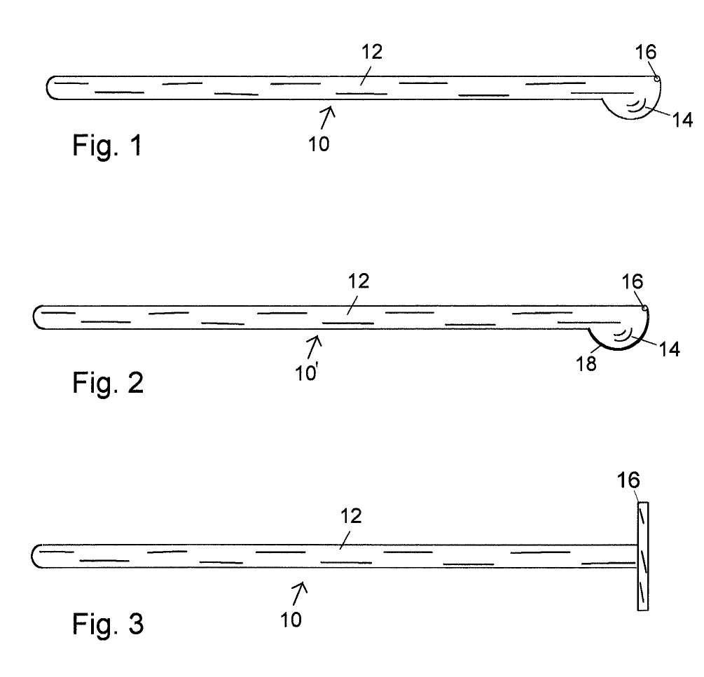

Bar 10 which constitutes an embodiment of the invention is seen in FIG. 1 to comprise an elongate shank 12 having at a first end thereof a broadened roll surface 14 contiguous therewith, and also a cross-bar 16 that extends equally laterally from each side of shank 12 at the distal extremity of that first end and oppositely across shank 12 from roll surface 14. For light weight, bar 10 can be made of fiberglass or, among the woods, preferably of white ash. As seen in FIG. 2, the same structure as that of FIG. 1 has in this case been adapted in bar 10′ to add a roll pad 18, which may comprise, for example, a layer of rubber or the like that serves to inhibit the sliding of roll surface 14 against a shop floor to which applied. FIG. 3 then shows a top plan view of bar 10 (or 10′) that illustrates more explicitly the structure of cross-bar 16 relative to shank 12.

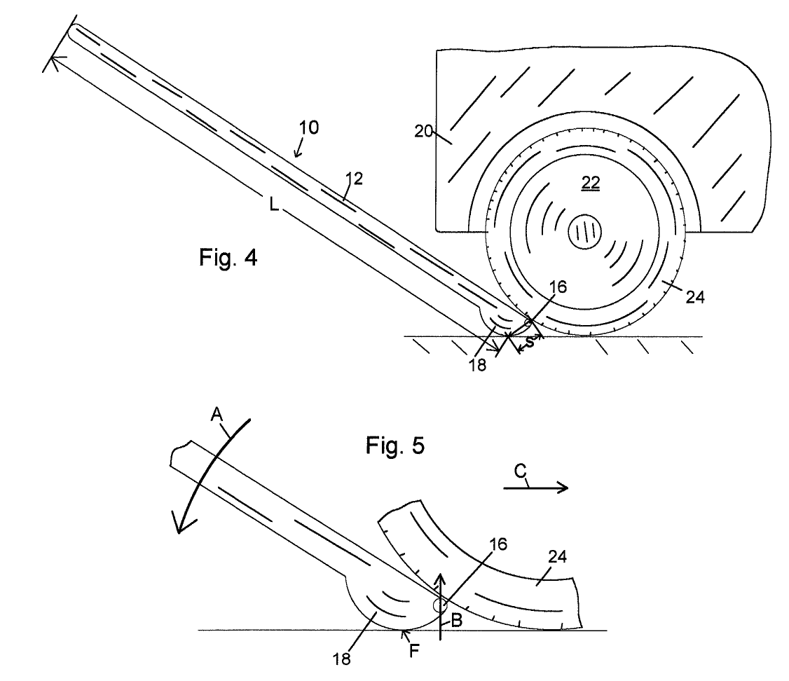

FIG. 4 now shows a process of using bar 10 for purposes of effecting some slight movement of a vehicle 20, of which a cutaway end portion thereof is shown in FIG. 4, by way of causing the rotation of a wheel 22 and contiguous tire 24. Bar 10 is disposed such that cross-piece 16 is abutted against an outer curved surface of tire 24, roll surface 14 is put into contact with a floor surface upon which tire 24 rests, and shank 12 may then have a force applied thereto so as to effect a force acting between cross-piece 16 and tire 24.

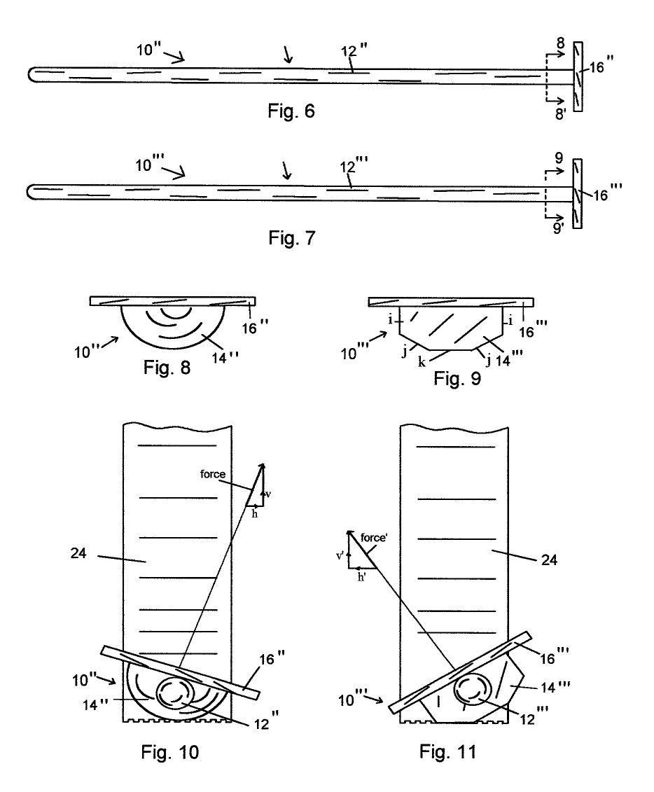

In more detail as shown in FIG. 5, identifying a fulcrum F as the point of contact between roll surface 14 (to which, of course, there might also have been interposed a roll pad 18 as in directing FIG. 2) and the underlying floor, application of a counter-clockwise downwardly rotating vector A to shank 12 gives rise through lever action to a vector B passing upwardly through cross-piece 16, and hence a tendency to rotate tire 24 and hence wheel 22 clockwise such that vehicle 20 will move in the direction of vector C. Bar 10 can of course be applied to any tire, either straight on as shown in FIGS. 4-5 or at an angle thereto in the case of a lack of space in which to maneuver, e.g., on the opposite side of tire 24 (reaching under the vehicle body) in the event motion in the direction opposite that shown is desired.

The mechanical advantage (MA) provided by a lever is given by the ratio of the length of the “forcing arm,” e.g., the distance “L” in FIG. 4, to the length of the “responding arm,” e.g., the distance “S” in FIG. 4, i.e., MA=S/L. Using a bar 10 of, say, five feet long, the distance “S” may be on the order of an inch or two, thereby giving an MA of around 30-60. Thus, a downward force on shank 12 of 100 lbs. along vector A of FIG. 5 could yield a force equivalent to 500 lbs. against tire 24 adequate to move quite large vehicles a short distance so long as the brakes on such a vehicle were not engaged and the transmission of the vehicle were not in gear.

Other arrangements and disposition of the aforesaid or like components, the descriptions of which are intended to be illustrative only and not limiting, may also be made without departing from the spirit and scope of the invention, which must be identified and determined only from the following claims and equivalents thereof.

I claim:

1. A vehicle moving bar comprising
an elongate shaft;
a lateral extension protruding from said shaft in a region near to one end thereof and including an outer periphery; and
a cross bar disposed equally bilaterally at right angles both to said shaft and to said lateral extension, at a distal extremity of said one end and at a side thereof opposite said lateral extension.

2. The vehicle moving bar of claim 1 wherein said outer periphery of said lateral extension is smoothly curved.

3. The vehicle moving bar of claim 1 wherein said outer periphery has a flattened surface as its outermost surface, said flattened surface lying parallel with a longitudinal axis of said cross bar.

4. The vehicle moving bar of claim 1 wherein said outer periphery of said lateral extension has disposed contiguous therewith a layer of anti-skid material.
